(19) United States
(12) Patent Application Publication
(10) Pub. No.: US 2009/0177596 A1
(43) Pub. Date: Jul. 9, 2009

(54) Method for risk free stock investment using very long term synthesized stock options or very long term option hedges

(76) Inventor: Forrest Anderson, Port Aransas, TX (US)

Correspondence Address: Forrest Anderson, P.O. Box 279, Port Aransas, TX, 78373, US

(21) Appl. No.: 12/006,647

(22) Filed: Jan. 4, 2008

(51) Int. Cl. G06Q 90/00

(52) U.S. Cl. 705/500

(57) ABSTRACT

An improved method for risk free, or low risk, stock investing using long or very long term options, or synthesized long or very long term options, or synthesized expirationless options These embodiments of the invention disclose a method for risk free, or low risk, stock investment that uses long or very long term options, or synthesized long or very long term options, or expirationless synthesized options. These options or synthesized options produce a very low annualized cost of taking a position in stocks. When these options or synthesized options are used in combination with safe interest bearing investments, risk free stock investment is achieved. These risk free stock investments can be further enhanced by the use of index ETFs (exchange traded funds). It is even possible to produce risk free stock investments that have a higher investment return than a direct investment in the stock.

### CROSS-REFERENCES TO RELATED APPLICATIONS

Not Applicable

### FEDERALLY SPONSORED RESEARCH

Not Applicable

### SEQUENCE LISTING OR PROGRAM

Not Applicable

### BACKGROUND

1. Field of the Invention

This invention relates to risk free or low risk stock investment using synthesized stock options or stock option hedges.

2. Description of the Prior Art

Prior art includes synthetic stock investing where a portion of the investment capital (typically 10%) is used to purchase a conventional exchange traded stock option and the remainder of the capital used invested in interest bearing investments, typically bonds, CDs, or money market funds. Because the options are shorter term the interest is not sufficient to offset the option premium costs, and the results produce lower returns than an investment in the underlying stock. Also since options on individual stock are typically used the higher volatility further reduces the returns. If the options are conventional 9 month (or shorter) term, the synthetic stock positions will lose money except when the stock price experiences a very large increase during the term of the investment. If the options are LEAPs (2½ year options), the investment return will still be less than a direct investment in the stock except during periods of very low volatility and relatively high interest rates.

Prior art also includes principal protected notes (PPNs). Each of these is structured as a note, and has its own terms and conditions for redemption and pay out. The terms are complex and vary greatly from one type of note to the next. The prospectus must be read very carefully. These notes have numerous disadvantages: They have relatively high expenses of several different types. All of the gains are treated as short term capital gains. Because they are traded on an exchange, they have a relatively high initial offering brokerage fee. The term of the investment is typically two years, and they can not be redeemed earlier.

Principal Protected Notes are Described in the Following:

CIBC World Markets “Structured Notes: Equity Index Linked Notes”, 1999, Arnovitz, Andrew C.; “Equity-Linked notes give RRSPs foreign exposure”, Canadian Jewish News, February 1999, Satyajit Das, “Credit Derivative; Products, Applications and Pricing” Wiley, John & Sons, Incorporated, Apr., Satyajit Das, “Structured Notes and Derivative Embedded Securities” (Euromoney Publications, January 1996. cited by examiner.

In the following description of the preferred embodiments occasional reference is made to structures and terms that are known in the prior art. In this regard the interested reader is directed to the disclosure of the following U.S. patents, which are incorporated herein by reference for all purposes: U.S. Pat. Nos. 4,346,442; 4,674,044; 4,677,552; 4,823,265; 4,953,085; 5,038,284; 5,101,353; 5,126,936; 5,132,899; 5,189,608; 5,210,687; 5,227,967; 5,262,942; 5,270,922; 5,557,517; 5,644,727; 5,682,466; 5,905,974; 5,802,501; 5,812,987; 5,884,286; ,946,667; 6,192,347; 6,263,321; 6,321,212; 5,946,667; 6,061,662; 6,546,375; 7,249,037; 7,287,006; 7,315,838; 7,315,842; and 7,249,075.

### SUMMARY

These embodiments describe investment positions in stock indexes that, under ideal conditions, can capture 99% or more of stock index price gains but have no possibility of incurring a loss. These investment positions can use index ETFs and synthesized very long term options, or expirationless synthesized options.

These embodiments disclose a method for risk free, or low risk, stock investment that can use synthesized very long term options, or expirationless synthesized options. These synthesized options produce a very low annualized cost of taking a position in stocks. When these synthesized options are used in combination with safe interest bearing investments, risk free stock investment can be achieved. These risk free stock investments can be further enhanced by the use of synthesized options on index ETFs (exchange traded funds). It is even possible to produce risk free stock investments that have a higher investment return than a direct investment in the stock.

The combination of synthesized very long term options and safe interest bearing investments produce a disproportionate synergism in producing a risk free stock investment. It is commonly believed that return on investment is proportional to risk, so a risk free stock investment with costs equal to a direct stock investment surprisingly violate a basic financial principle.

The advantages of very long term options have not been adequately understood: They have much lower annualized time value decay. That, combined with safe interest bearing investments that compensate for the annualized time value decay make risk free stock investment possible. As will be shown later, higher interest rates can even be beneficial to these investments. That is a surprising result since the option premium is higher—but the higher premium is more than overcome by the higher yield from the interest bearing investment.

The gains on the option portion of the risk free, or tow risk, stock investment are taxed as long term capital gains. The investment does not need to be put into a form to allow it to be traded on an exchange, and so there is no high initial offering brokerage fee.

The investment makes use of synthesized very long term options that allow very low annualized cost of taking a position in stocks, and make possible investment positions in stocks that, under ideal conditions, will capture 99% or more of stock price gains, but have no possibility of incurring a loss.

### DRAWINGS—FIGURES

FIG. 1 shows BS SPY Accuracy Check

FIG. 2 shows ATM Loan Rate

FIG. 3 shows 24 month ATM Loan Rate

FIG. 4 shows 24 month ATM Loan Rate vs Interest Rates

FIG. 5 shows 30 month Sequences ROI

FIG. 6 shows 24 month Sequences ROI

FIG. 7 shows volatility 15, 30 month Sequences ROI

FIG. 8 shows volatility 20, 30 month Sequences ROI

FIG. 9 shows volatility 20, 30 month High Rate Sequences ROI

FIG. 10 shows volatility 20, 6 month Conventional Sequences ROI

FIG. 11 shows ATM 7 Year Loan Rate

FIG. 12 shows 7 Year ATM Loan Rate

FIG. 13 shows 7 Year ATM Loan Rate vs Interst ates

FIG. 14 shows 7 Year Option Stock Position

FIG. 15 shows synthesized very long term option investment

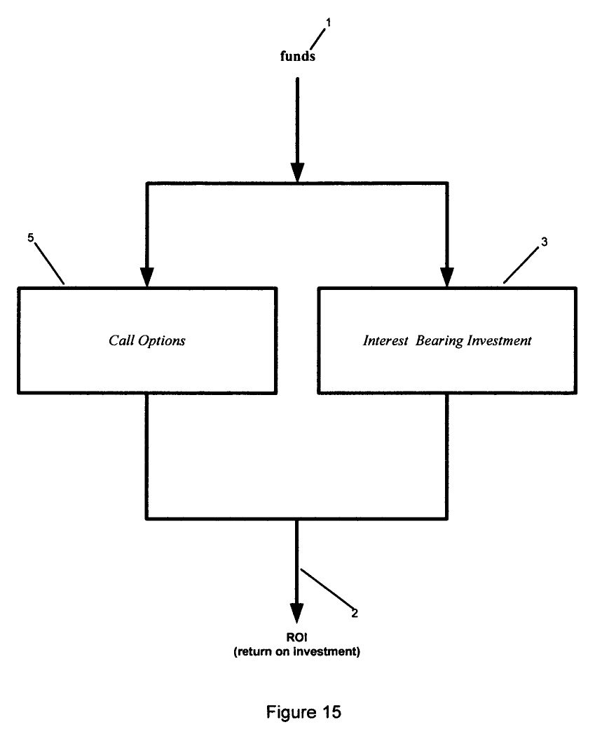

FIG. 16 shows synthesized expirationless option investment

FIG. 17 shows typical steps in the method of the investment

### DETAILED DESCRIPTION

Background—The Black Scholes Merton Model and its Verification

The Black-Scholes-Merton equation (Black, F. and M. Scholes, May/June 1973) (Merton, Robert C., 1973) was implemented in Matlab. The Merton modification was included to allow dividends. A volatility function was implemented so that volatility was a function of moneyness (intrinsic value) and time remaining on the option. The volatility function was calibrated using the bid/ask mean of actual market data on a particular ‘calibration’ day.

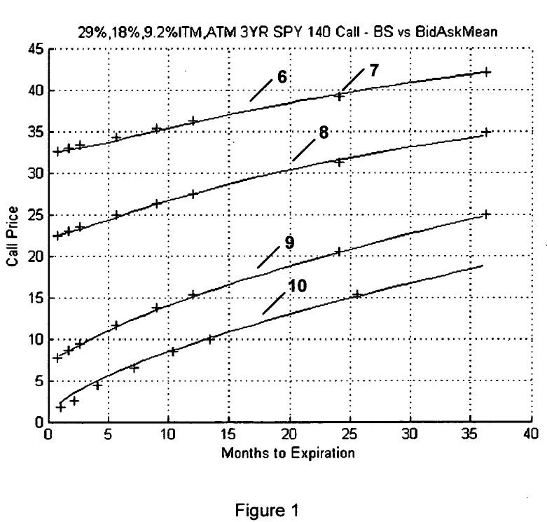

FIG. 1 shows the computed option values 6 compared to the actual market data 7 on the ‘calibration’ day for in the money (ITM) 6,8,9 and ATM 10 options on SPY, the SP500 ETF. Market data is denoted by +.

It can be seen that the Black-Scholes-Merton equation results very closely match the actual market data.

Black-Scholes-Merton equation simulation software is available from Mathworks and many other sources. Black-Scholes-Merton equation simulation is also available on the internet in ‘real time’ where the parameter values may be supplied and the option's value will be shown. Other option pricing equations or algorithms can also be used to produce the following results and to implement the invention, such as the Binomial Tree, whaley, and many others.

Background—Synthesized Options

Synthesized Options are hedge positions that replicate the payoff of the option. The methods used to construct these hedge positions (conventional hedge positions) are well known—for example see “Black-Scholes and Beyond”, Neil A. Chriss, McGraw Hill, 1997 or “Basic Black-Scholes: Option Pricing and Trading”, Timothy Crack, 2004. They are commonly used every day by option specialists or market makers on the various stock and option exchanges such as the CBOE to hedge short positions in conventional exchange traded options, including LEAPs. When the option specialist or market maker creates a new option and sells it, he creates a hedge position to make his short option position market neutral (or to replicate the payoff of the option—which is the same thing as making his position market neutral). For a call option, these hedge positions typically consist of a long position in a portion of the underlying stock and a short cash position (a loan). During the lifetime of the option or hedge, these positions are periodically re-balanced in such a way so that no new funds are required.

One example of hedging is Delta hedging: The delta of a derivative (option or call option) can be used to hedge a holding of the derivative with a position in the underlying security or vice-versa. The number of units in the underlying security needed to hedge (or which can be hedged by) a derivative is equal to the delta of the derivative. Delta hedging is used to cover trading positions, and to arbitrage differences between the cost of the derivative and the cost of buying enough of the underlying to delta hedge it. The delta changes with the price of the underlying, so a delta hedge must be continuously rebalanced.

As a delta hedge can be used to hedge a position in a derivative, by reversing the hedge, and combining this with cash or debt, one can replicate the cash flows of the derivative. Black Scholes formulas provide formulas for computing delta and computing the initial amount of cash or debt (ie. the amount of cash is negative).

Another example of hedging is Gamma hedging: The main shortcoming of delta hedging is that a delta hedge requires frequent re-balancing. When ever the price of a security changes, so does the delta of any derivative based on it. When the delta changes significantly, the composition of any delta hedged portfolio will need to be changed. The greater the change in the delta, the greater the change that is needed in a delta hedged portfolio. Therefore the amount of re-balancing needed can be reduced by reducing the amount by which the delta changes for a price movement—in other words by reducing the rate of change of the delta, which we call the gamma. A gamma hedged, or gamma neutral, portfolio will need to be re-balanced less than one what is only delta hedged. It will still need re-balancing, especially if there are large price movements, because the gamma, like the delta, changes with underlying price. Gamma hedging is also more complex because it requires holding two derivatives to hedge a each holding of a single security.

Background—Terminology:

The following is terminology that will be used in describing the invention:

Synthesized Very Long Term Options are the long term (over 2.5 years) version of the Synthesized Options previously described. Synthesized Very Long Term Call Options are the very long term (over 2.5 years) call option version of these Synthesized Options.

These Synthesized Very Long Term Options, or hedge positions, are not used in the normal options business, as these types of options are not normally available. However the methods used to construct these hedge positions are the same as the methods used to construct conventional hedge positions.

Synthesized Expirationless Options are Synthesized Options that replicate the payoff of the option that has no expiration date. The construction of these hedge positions is well known—for example see “Continuous Time Finance”, Robert C. Merton, Blackwell, 1992. Synthesized Expirationless Call Options are hedge positions that replicate the payoff of a call option that has no expiration date.

Synthesized Very Long Dated Call Options 4 are Synthesized Very Long Term Call Options or Synthesized Expirationless Call Options.

Very Long Dated Call Options 4 are call options that are sold and then hedged with Synthesized Very Long Dated Call Options.

### Background—Index ETFs

Index ETFs are exchange traded funds that are comprised of the stocks in a stock index such as the SP500.

Background—Safe Interest Bearing Investment.

Safe Interest Bearing Investment 3 comprises savings accounts, CDs, high rated bonds, government bonds, high rated zero coupon bonds, or other relatively safe investments with an adequate yield. The Interest Bearing Investment Interest Rate is the annual yield from the Interest Bearing Investment.

Background—Option's Underlying Stock Position Value

The Option's Underlying Stock Position Value is the total value of the stock that the call option or synthesized call option provides a right to purchase, that is, it is the number of shares times the present price per share.

Background—Stock Position Cost

The Stock Position Cost (stock position equivalent interest rate or stock position equivalent loan rate) is the at the money (ATM) option price, or premium, divided by the product of Option's Underlying Stock Position Value and the option's duration in years {ie. money (ATM) option price Option's Underlying Stock Position Value * option duration in years}. This gives the annualized cost of establishing a position in the stock by purchasing an ATM, at the money, call option.

Background—ROI, Risk Free, and Low Risk

The Value of the Investment at the end of the investment's term is the sum of the Very Long Dated Call Options value and the Interest Bearing Investment plus its accrued interest.

The Return on Investment (ROI) at the end of the investment's term is the Value of the Investment divided by the initial investment 43. This may be given as a fraction or given in percent.

Risk Free is when the minimum possible ROI is greater or equal to zero. Low Risk is when the minimum possible ROI is greater or equal to minus five percent (−0.05).

Background—Examples of Conventional Low Risk Stock Investing using ETFs and LEAPs:

Conventional low risk stock investing using ETFs and LEAPs are used to illustrate conventional stock investing which will provide a background for describing the embodiments: LEAPs are more familiar than the entities used in the embodiments of the invention, and their actual market prices are readily available so the results can be verified with actual data.

As an alternative to investing in stock, the investor can create ETF/LEAP stock positions. Methods are discussed for doing this and achieving good results. Examples are given of ETF/LEAP stock positions. Models are presented of effects of volatility and Black Scholes interest rates on ETF/LEAP stock position returns. Investment efficiency is examined by comparing ETF/LEAP stock position returns with ETF stock price appreciation.

Stock positions can be constructed by purchasing at the money (ATM) call options 5 on the stock with a small portion of the funds 1 to be invested, and putting the remainder of the funds in short term bonds, CDs, or the equivalent (Interest Bearing Investment 3). These positions have no leverage just as a conventional stock investment has none.

However stock positions constructed with conventional short term options on individual stocks have costs so high that they are not profitable without large increases in the stock price, and they can lose money with only small increases in stock price.

For example, on Dec. 28, 2006 Time Warner (TWX) was trading at 22.0. The July 2007 22.5 call (205 day) had a bid/ask mean of 1.25. So a 6.8 month $22,000 stock position can be constructed by buying 10 contracts (1000 calls) for $1250, and investing the remaining $20,750 in 5.1% 7 month CDs which will pay $599 in interest during the 6.8 month investment period.

Then the maximum loss is $1250−$599=$651, which is also the amount by which the 1000 share TWX position's value must increase for the investment to break even—which is a 5.2% annual price increase rate. Note that if the TWX price increases at an annual rate higher than than 5.2%, the investment return will still be reduced by 5.2%. This investment will have a maximum loss rate of 5.2%/year.

In contrast, stock index ETFs (SPY, QQQQ, . . . ) and long term options (LEAPS) allow lower cost positions where the option premium is paid off (or nearly paid off, or more than paid off) by the bond (or CD) interest during the term of the investment. If the premium is paid off, these positions will not lose money even if the ETF price declines, and can capture over ninety percent of ETF price increases as small as one percent, and over ninety nine percent of larger price increases.

For example, on Nov. 15, 2006 the SP500 ETF (SPY) was trading at 140.02. The December 2008 140.0 call (766 day, 25.5 month) had a bid/ask mean of 15.3. So a 25.5 month $14,000 stock position can be constructed by buying 1 contract (100 calls) for $1530, and investing the remaining $12,470 in 5.1% 26 month CDs which will pay $1351 in interest during the 25.5 month investment period.

So the maximum loss is $1530−$1351=$179, which is also the amount by which the 100 share SPY position's value must increase for the investment to break even—which is a 0.6% annual price increase rate.

This investment will have a positive return for a stock price appreciation rate of 1%, and will have a maximum loss rate of 0.6%/year, nearly one tenth that of the previous investment.

Index ETFs and LEAPS

Index ETFs have lower volatility than individual stocks, and hence, lower option prices. Long term options (LEAPS) have lower option prices in terms of dollars of option premium per dollar of position equity per year (“stock position cost”). The combination yields a much lower stock position cost for ETF/LEAP stock positions when compared with stock positions constructed with individual stocks and conventional options.

Index ETFs have lower volatility because they are composed of numerous individual stocks with price movements that are not completely correlated. Many now have LEAPs, for example: DIA (Dow 30), SPY (SP500), QQQQ (NASDAQ100) MDY (SP MidCap), IWM (Russel2000—small cap), EFA (EAFE—Europe, Austrailia, Far East), EEM (Emerging Market). A diversified portfolio can be constructed from options on these ETFs.

In the Black-Scholes-Merton formula, these index ETFs differ from each other by values of their dividends and their volatility.

The LEAP Cycle and the Investment Cycle

New index ETF LEAPs are issued, with few exceptions, in June, July, and August. They are typically 30 months in duration, and expire in December, January, and February. So it is not possible to construct a continuous sequence of 30 month ETF/LEAP stock positions since when the new options are issued the existing options have 6 months left until expiration.

A continuous sequence of 24 month ETF/LEAP stock positions can be constructed by selling the existing option during the summer when it has 6 months remaining and buying the new 30 month option. Also a sequence can be constructed by selling the existing option during the end of the year when it is nearing expiration and buying the new option when it has 24 months remaining.

Stock Position Cost and Risk

The Stock Position Cost, which is ATM option price/(underlying stock price*option duration in years), is used to compare the relative annualized expense of ATM options when used to create ETF/LEAP stock positions. In constructing a position if the stock position cost is less than or equal to the interest bearing investment interest rate (bond or CD yield), the option premium will be paid off by the bond interest during the lifetime of the position. Option premium is the option's cost minus its intrinsic value, where intrinsic value is the stock price minus the strike price. For ATM options intrinsic value is zero.

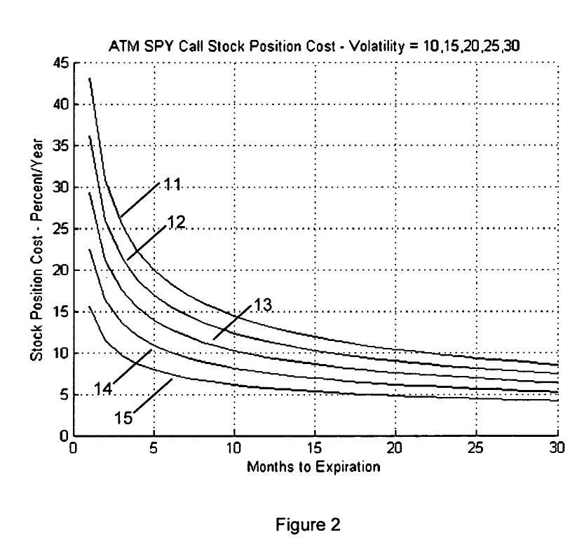

In FIG. 2 stock position cost is plotted against option time with volatility as a parameter. The volatilities in the 5 plots are from top to bottom: 30% 11, 25% 12, 20% 13, 15% 14, 10% 15. It can be seen that the stock position cost increases with volatility and decreases with longer option length.

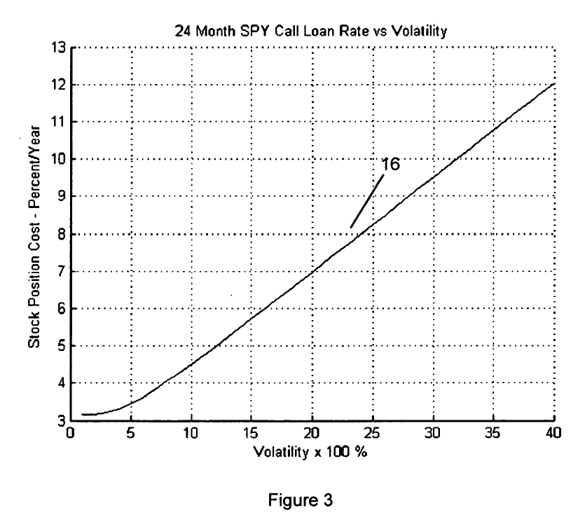

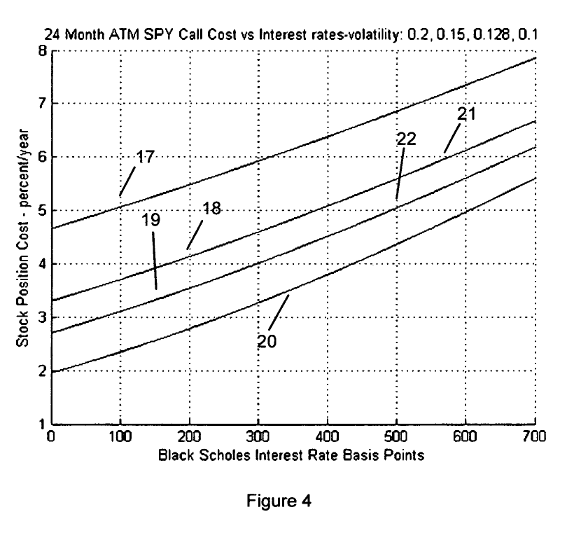

As previously discussed, the LEAP option cycles cause the ETF/LEAP stock position duration to be 24 months, so that case is examined in more detail in FIG. 3 and FIG. 4.

FIG. 3 shows 24 month SPY ATM call based stock position cost 16 as a function of volatility. It can be seen that the stock position cost stays below 5% for volatilities less than 0.125. Beyond 0.125, a bond interest rate of 5% will not pay off the option premium during the duration of the investment, and there will be a possiblity of a loss equal to stock position cost minus bond interest rate. The return on investment (ROI) will also be reduced by this amount. For example, for volatility equal to 0.2 (20%), there will be a possibility of a 2%/year loss, and ROI will also be reduced by 2% (for example, from 10% to 8%).

Of the ETFs previously mentioned, SPY typically has the lowest volatility. For the Black-Scholes-Merton model used here, a volatility of 0.128, without skew, has produced results that match the ATM SPY market data bid/ask means on the calibration date. The other ETFs have required volatilities that are from 1% to 3% higher. So in the present market only SPY allows a no risk position. The other ETFs have maximum possible losses ranging from 1-3%/year.

FIG. 4 shows 24 month SPY ATM call stock position cost as a function of Black Scholes interest rate with volatility as a parameter: 20% 17, 15% 18, 12.8% 19, 10% 20. For volatility of 12.8% or less, the stock position cost is less than the Black Scholes interest rate. The Black Scholes interest rate is the rate used in the Black Scholes formula.

If the interest bearing investment interest rate (CD/bond rate) is the same as the Black Scholes interest rate, then it can be seen that higher interest rates allow risk free positions with higher volatilities. For example, for 6% rates, the 6% levels on the two axis intersect on the 15% volatility curve 21. The 5% levels intersect near the 12.8% curve 22, and the 4% levels intersect near the 10% curve.

So higher interest rates can be helpful with ETF/LEAP stock position investments.

ETF/LEAP Stock Position Investment Results

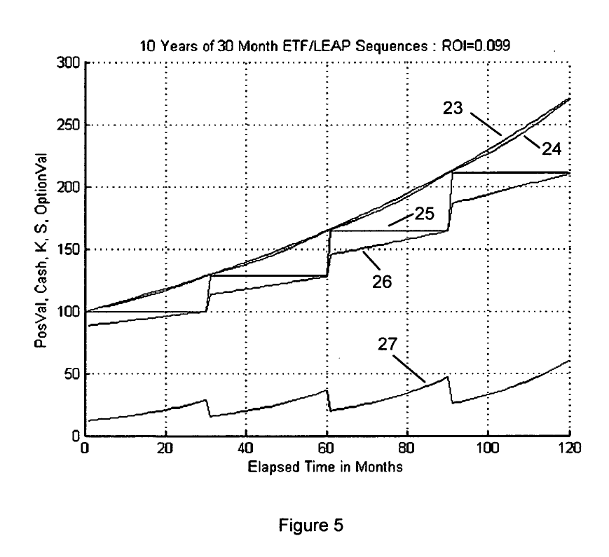

FIGS. 5,6,7,8,9 and 10 show the results of a sequence of ETF/LEAP stock position investments over a 10 year period. ETF price appreciation is a constant 10%/year over the 10 year period. The results show how much of the 10% the ETF/LEAP stock position investments capture in their ROI 2.

There are 5 plots in each figure. They are from top to bottom: stock price 23, investment position value 24, option strike price 25, and option value 26 and bond/CD value 27. Note that investment position value is equal to option value plus bond/CD value.

The uppermost plot 23 is the ETF's market price which is increasing at a 10% annual rate. The locations where the existing option is sold and a new ATM option is purchased are clearly evident with the steps in the strike price 25, the third plot. When the existing option is sold and a new ATM option is purchased the difference in option prices is added to the bond/CD value 27, the fourth plot. This can be seen in the steps in the bond/CD value. In between steps, the bond/CD value increases in accordance with the bond/CD annual interest rate. The lowest plot, the fifth plot, shows the value of the currently held option 26. This option value increases per the Black Scholes Merton formula. At each step it resets to the newly purchased option's value. The second plot is the investment position's value which is the sum of the option value and the bond/CD value.

In FIG. 5 the ROI 2 resulting from a sequence of 30 month ETF/LEAP stock positions in SPY is shown. Note that this 30 month ETF/LEAP sequence is not possible in practice because of the LEAP option cycles, as previously explained. It is included for comparison with the following to show the effects on investment return of selling 6 months early to achieve the 24 month ETF/LEAP sequence.

Here the ROI is 0.099, so 99% of the stock price appreciation is captured when the 30 month option is held to expiration before buying a new option.

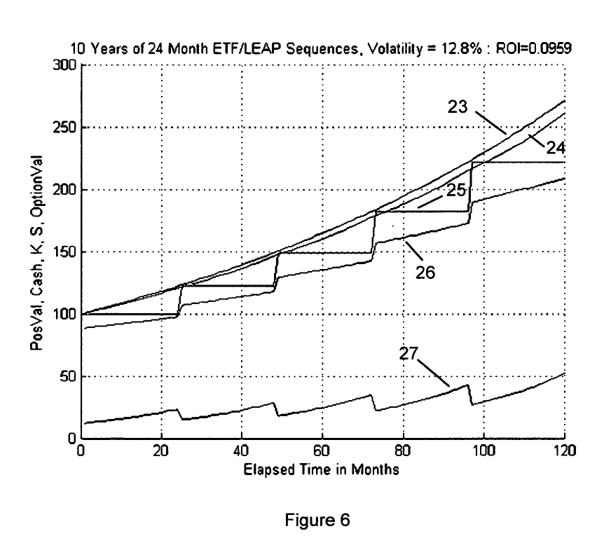

In FIG. 6 the ROI resulting from a sequence of 24 month ETF/LEAP stock positions in SPY with volatility=12.8% is shown.

In this case the ROI is 0.096, so 96% of the stock price appreciation is captured. Selling 6 months early reduces the ROI by 3%.

Effects of Volatility on ROI are Examined Next:

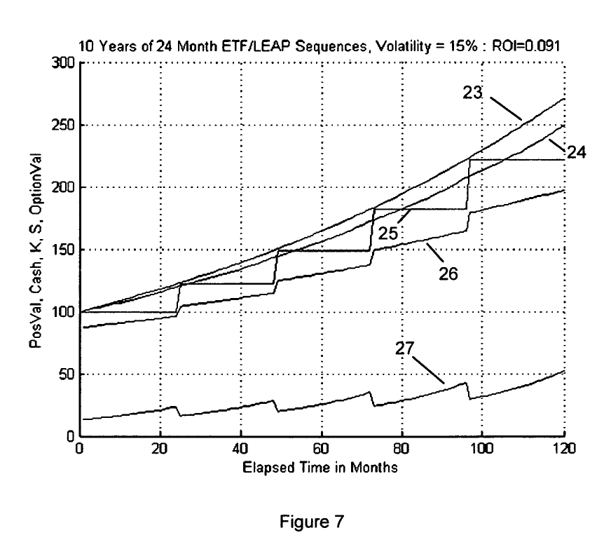

In FIG. 7 the ROI resulting from a sequence of 24 month ETF/LEAP stock positions in SPY with volatility=15% is shown. A volatility increase from 12.8% to 15% has deceased the ROI from 0.096 to 0.091, or 0.5%, which is in accordance with the data in FIG. 3.

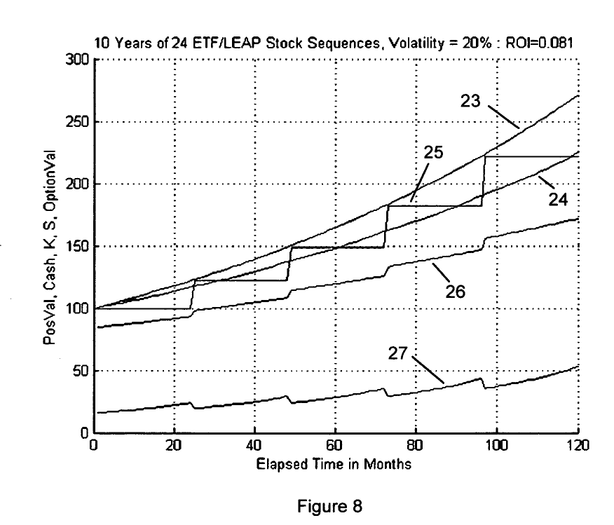

In FIG. 8 the ROI resulting from a sequence of 24 month ETF/LEAP stock positions in SPY with volatility=20% is shown. A volatility increase to 20% has deceased the ROI to 0.081, or by 1.5 from the level of the ROI for a volatility of 12.8%, which is also in accordance with the data in FIG. 3. This is a reduction of the ROI by 15%. Only 81% of the ETF stock price appreciation is being captured.

The ETF/LEAP stock position's ability to capture the ETF stock price appreciation is substantially effected by volatility. Next, interest rate effects will be examined.

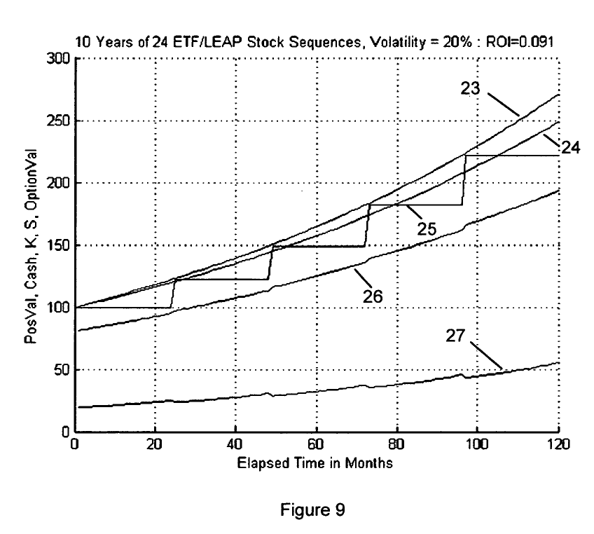

FIG. 9 shows that high interest rates, 8%, compensate for high volatility as is shown in FIG. 4. The ROI is 9.1% even though the volatility is 20%. Previously in FIG. 8 an ROI of only 8.1% was achieved.

The Black Scholes interest and cash position (bond/CD) annual interest rate were both 8%, whereas they previously were 5.25% and 5.05% respectively.

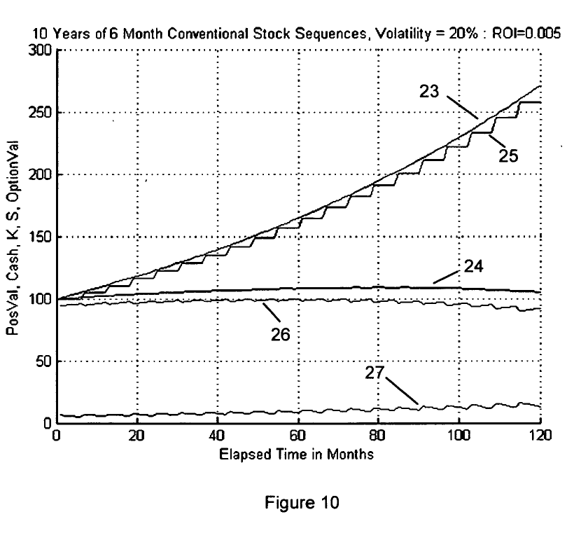

As a counter example to the ETF/LEAP stock position, FIG. 10 gives the results of a 10 year sequence of positions constructed with conventional 6 month options on an individual non ETF stock with a volatility of 20%.

Although stock price appreciation was 10%/year, the sequence of investments produced an ROI of only 0.5%. The high price of the 6 month option combined with the effects of the high volatility, reduced the ROI to near zero. The newly purchased option's price is so high that selling the existing option and buying the new option produces a negative cash contribution.

The common variable values used for FIGS. 6, 7 and 8 in the Black Scholes Merton formula were:

| | |
|---|---|
| SP500 dividend | 0.0185 |
| Black Scholes interest rate | 0.0525 |
| annual stock price increase | 0.1 |
| cash position (bond/CD) annual interest rate | 0.0505 |
| initial option length in months | 30 |
| initial stock price | 100 |
| strike price | 100 |

In FIG. 10 initial option length in months was 30. In FIG. 9 the Black Scholes interest and cash position (bond/CD) annual interest rate were both 8%.

### Detailed Description Of First Embodiment

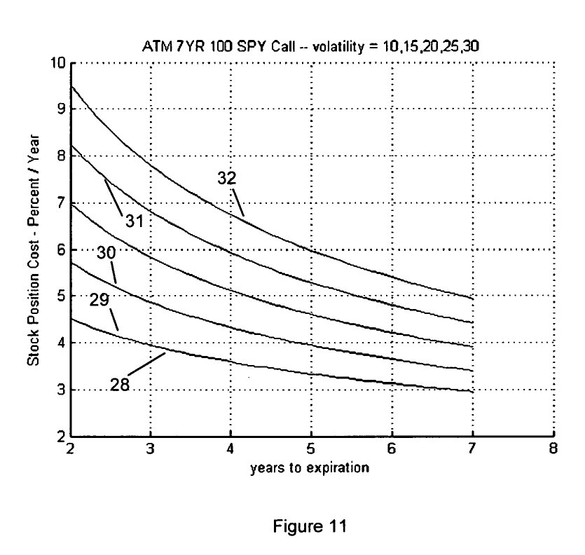

Greatly Improved Low Risk or Risk Free Stock Investing using Synthesized Very Long Term Options: Conventional ETF/LEAP synthetic stock positions are limited to ETFs that have LEAPs available. In the embodiments synthesized options can be constructed for any ETF or other exchange traded equity. Conventional ETF/LEAP synthetic stock positions are also limited to a 24 month call option duration for reasons discussed previously—one of them being that new LEAPs are issued as 30 month options. If longer term options were available the stock position cost would be lower. This is shown in FIG. 11 for a 7 year ATM SPY call option. FIG. 11 shows stock position cost as a function of time for volatilities: 10% 28, 15% 29, 20% 30, 25% 31, 30% 32.

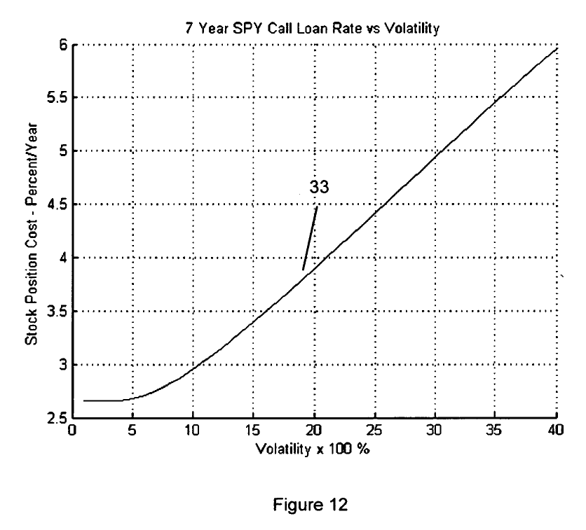

A 7 year option would also provide lower stock position cost at higher volatility as is shown in FIG. 12. Here a volatility of 30% has a stock position cost 33 of only 5% per year.

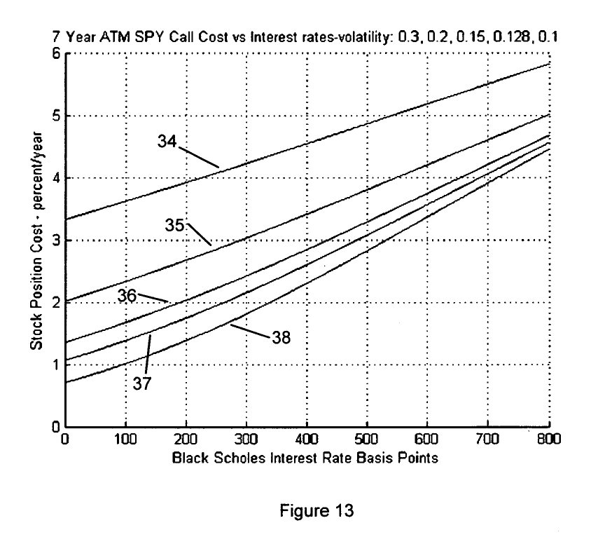

FIG. 13 shows 7 year Black Scholes hedge stock position cost as a function of interest rates for volatilities: 30% 34, 20% 35, 15% 36, 12.8% 37, 10% 38.

With a volatility of 30%, and interest rate of 6%, stock position cost is only 5.2%/year. So if the ETF price declined during the 7 year period, the investment would still return a positive 0.8%/year. With reasonable stock position cost at high volatility, zero risk investments in individual stocks (vs. index ETFs) is possible.

With a volatility of 15%, and interest rate of 5%, stock position cost is only 3.3%/year. With an ETF price rising at a 10%/year rate the investment would return 11.7%/year.

These longer term options, Synthesized Very Long Dated Call Options 4 can be synthesized by initially buying a certain amount of the ETF stock and borrowing a certain amount of cash as a loan. The specific amounts of each can be determined by the Black Scholes formula (or other appropriate formulas). Then afterwards, during the time period of the investment, the investment would be frequently adjusted by buying or selling ETF stock, and then borrowing more cash or repaying down the loan to balance out the buying or selling of the stock. This is done in such a way so that no additional cash flows into or out of the investment occur. The adjustments to the ETF stock position are determined by changes in the delta of the option (and possibly other hedge parameters such as gamma, theta, rho, vega. These parameters are well known.). The adjustments to the loan position can be determined by the Black Scholes formula. (These methods for creating an option hedge are well known—for example see “Black-Scholes and Beyond”, Neil A. Chriss, McGraw Hill, 1997 for information on the foregoing option synthesis methods.)

This synthesized option would have the same value as the Black Scholes value of the call option at any point in time, and would have the same pay out at expiration. This is the Black Scholes hedge (for example see “Black-Scholes and Beyond”, Neil A. Chriss, McGraw Hill, 1997). It is equivalent to owning the call option.

There are other methods for hedging a call option, for example see: Haug, Espen Gaarder, 1997, “The Complete Guide to Option Pricing formulas”, McGraw Hill, New York, N.Y.; Wilmott, Paul, Sam Howison, and Jeff Dewynne, 1997, “The Mathematics of Financial Derivatives”, Cambridge University Press, Cambridge, England; Whaley, R. E., “On the Valuation of American Call Options with Known Dividends”, Journal of Financial Economics 9, no. 2, June 1981; Cox J., Ross S., Rubinstein, M., “Option Pricing: A Simlified approach”, Journal of Financial Economics 7, September 1979. Any of these other methods, including methods not included in these references, could be used to create the Synthesized Very Long Dated Option 4.

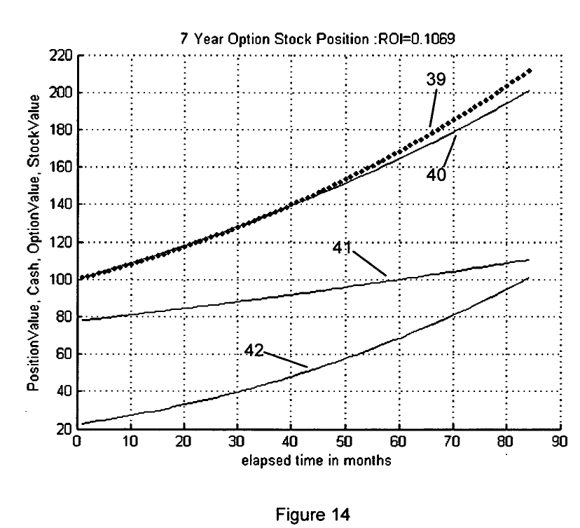

FIG. 14 shows a 7 year Black Scholes hedge stock position value (dotted line 39) as a function of time. There are 4 plots. They are from top to bottom: investment position value (dotted), stock price 40, bond/CD value 41, and option value 42. Note that Value of the Investment is equal to option value plus bond/CD value.

The Return on Investment, ROI, is actually greater than the stock price return—10.6% vs. 10%.

### Detailed Description Of Second Embodiment

Greatly Improved Low Risk Stock or Risk Free Investing using Synthesized Expirationless Options: If an expirationless option is created, then a hedge which replicates its payoff must be created. This hedges are Synthesized Expirationless Call Options. The creation of expirationless options is explained, for example, in (Merton, Robert C. “Continuous Time Finance”, Cambridge, Mass., Blackwell, 1990), (Merton, Robert C. “Theory of Rational Option Pricing”, Bell Journal of Econometrics and Management Science, Spring 1973, 141-183, U.S. Pat. No. 5,557,517, (Robert McDonald and Daniel Siegel. “The value of waiting to invest”, Quarterly Journal of Economics, pages 707-727, November 1986), (Robert L McDonald. “Derivatives Markets.”, Addison Wesley, 2002), (Mark Shackleton, Rafal Wojakowski (2002) “The Expected Return and Exercise Time of Merton-style Real Options “Journal of Business Finance & Accounting 29 (3&4), 541-555.). These expirationless options can have zero annualized time value decay. These Synthesized Expirationless Call Options can be used as the Synthesized Very Dated Call Options 4 in the method described in the First Embodiment to implement low risk stock investing.

### Detailed Description of an Example of the Steps in the Method of Either Embodiment

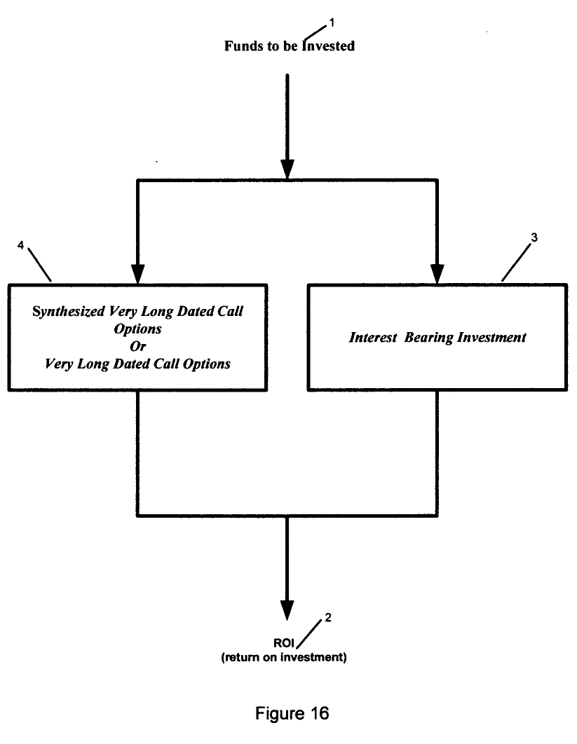

In either embodiment Synthesized Expirationless Call Options or Synthesized Very Long Term Call Options are shown as Synthesized Very Long Dated Call Options 4 in FIG. 16. In FIG. 16 the Funds to be Invested 1 are used to create the Synthesized Very Long Dated Call Options 4 and purchase the Interest Bearing Investment 3. For example, 10% of the Funds to be Invested might be used to create the Synthesized Very Long Dated Call Options and the remaining 90% are used to purchase the Interest Bearing Investment. The percentage of the Funds to be Invested that will be used to create the Synthesized Very Long Dated Call Options for example can be determined by the amount of funds required to cause the Option's Underlying Stock Position Value to be equal to the Funds to be Invested. The remainder of the Funds to be Invested can then be used to purchase the Interest Bearing Investment.

After the term of the investment (for example 7 years), the return on the investment, ROI 2, is produced by combining the accrued interest from the the Interest Bearing Investment with the appreciation or depreciation of the Synthesized Very Long Dated Call Options.

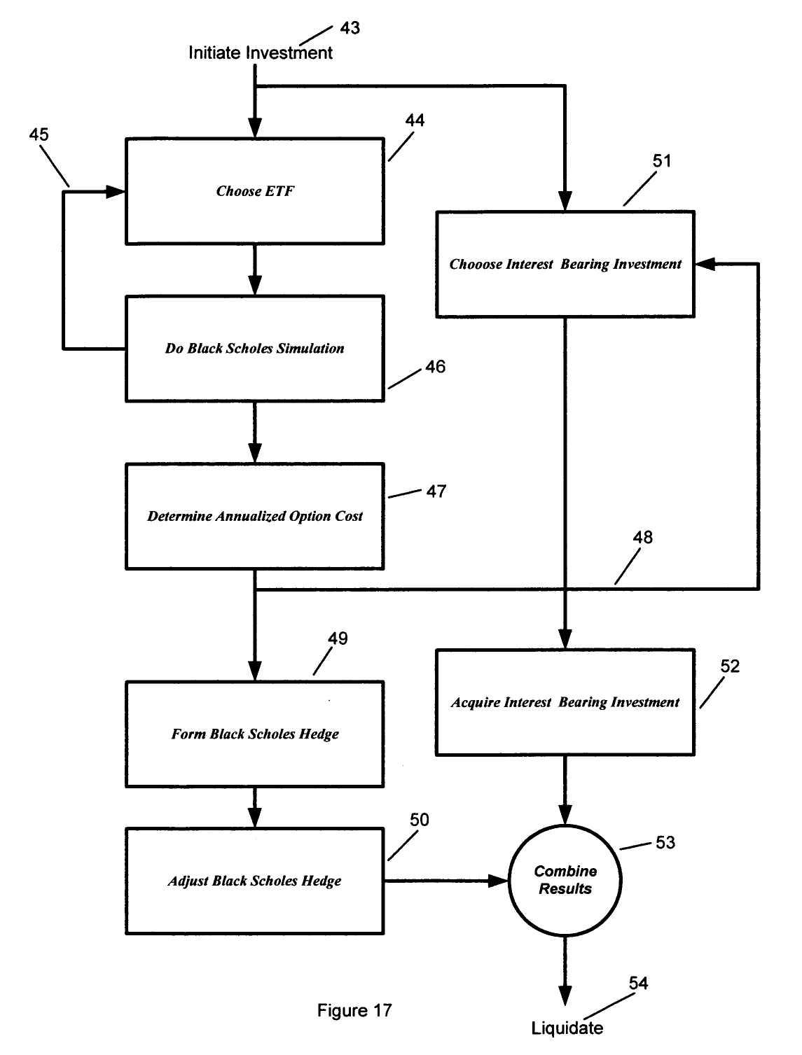

The steps in the method of either embodiment are further illustrated in FIG. 17. The investment is initiated 43 by choosing an ETF as the underlying for the Synthesized Very Long Dated Call Options and choosing an Interest Bearing Investment 51. Simulation 46 can be done using the Black Scholes formula (or other option pricing formula) to determine the option's annualized cost 47. This can be compared 48 with the Interest Bearing Investment's yield, and the choice of ETF and Interest Bearing Investment are adjusted if required so that the Interest Bearing Investmen Interest Rate offsets the option's annualized cost more completely. The Interest Bearing Investment can then be acquired 52 and the Synthesized Very Long Dated Call Options can be created by forming the hedge position 49. The hedge should be adjusted 50 during the life of the investment per the normal process of option hedging (using any of the option hedging processes, as previously discussed). To liquidate 54, the Synthesized Very Long Dated Call Options and the Interest Bearing Investment are liquidated—value of the hedge is combined 53 with the value of the Interest Bearing Investment plus its accrued interest at the end of the term of the investment to produce the final Value of the Investment.

### Advantages of the Invention

The combination of synthesized very long term call options and safe interest bearing investments produce a disproportionate synergism in producing a risk free stock investment. It is commonly believed that return on investment is proportional to risk, so a risk free stock investment with costs equal to a direct stock investment surprisingly violate a basic financial principle. The advantages of very long term call options have not been adequately understood: They have much lower annualized time value decay. That, combined with safe interest bearing investments, make risk free stock investment possible. Higher interest rates can even be beneficial to these investments. That is unexpected since the option premium is higher—but the higher premium is more than overcome by the higher yield from the interest bearing investment.

Conclusions, Ramifications, and Scope

Although the description above contains many specifics, these should not be construed as limiting the scope of the embodiment but as merely providing illustrations of some of the present embodiments. The scope of the embodiment should be determined by the claims and their legal equivalents, rather than by the examples given.

1. A method of investing funds comprising:
(a) purchasing Very Long Dated Call Options with a portion of the funds,
(b) investing the remainder of the funds in an Interest Bearing Investment,
whereby a low risk or risk free investment is created.

2. A method of investing funds in stock comprising:
(a) synthesizing Synthesized Very Long Dated Call Options on the stock with a portion of the funds,
(b) investing the remainder of the funds in an Interest Bearing Investment,
whereby a low risk or risk free investment is created.

3-14. (canceled)

15. A method of investing funds comprising:
(a) purchasing Very Long Dated Call Options,
(b) investing in an Interest Bearing Investment, whereby a low risk or risk free investment is created.

16. The method of claim 1) wherein the Very Long Dated Call Options are options that are hedged with Synthesized Very Long Term Call Options.

17. The method of claim 1) wherein the Very Long Dated Call Options are options that are hedged with Synthesized Expirationless Call Options.

18. The method of claim 2) wherein the Synthesized Very Long Dated Call Options are Synthesized Very Long Term Call Options.

19. The method of claim 2) wherein the Synthesized Very Long Dated Call Options are Synthesized Expirationless Call Options.

20. The method of claim 16) wherein the method of investing funds creates a Risk Free Investment.

21. The method of claim 17) wherein the method of investing funds creates a Risk Free Investment.

22. The method of claim 18) wherein the method of investing funds creates a Risk Free Investment.

23. The method of claim 19) wherein the method of investing funds creates a Risk Free Investment.

24. The method of claim 16) wherein the method of investing funds creates a Low Risk Investment.

25. The method of claim 17) wherein the method of investing funds creates a Low Risk Investment.

26. The method of claim 18) wherein the method of investing funds creates a Low Risk Investment.

27. The method of claim 19) wherein the method of investing funds creates a Low Risk Investment.

28. The method of claim 3) wherein the Very Long Dated Call Options are options that are hedged with Synthesized Very Long Term Call Options.

29. The method of claim 3) wherein the Very Long Dated Call Options are options that are hedged with Synthesized Expirationless Call Options.

30. The method of claim 28) wherein the method of investing funds creates a Risk Free Investment.

31. The method of claim 29) wherein the method of investing funds creates a Risk Free Investment.

32. The method of claim 28) wherein the method of investing funds creates a Low Risk Investment.
